(19) United States
(12) Patent Application Publication
(10) Pub. No.: US 2007/0159306 A1
(43) Pub. Date: Jul. 12, 2007

(54) Recording and playing alarm clock

(76) Inventors: Benjamin Cody Smith, Jacksonville, OR (US); Armand A. Medeiros, Cleveland, TX (US)

Correspondence Address: Mr. Benjamin C. Smith, 2525 Cady Road, Jacksonville, OR, 97530, US

(21) Appl. No.: 11/329,888

(22) Filed: Jan. 12, 2006

(51) Int. Cl. G08B 1/00; G04B 23/02

(52) U.S. Cl. 340/309.7; 368/244

(57) ABSTRACT

1. This invention is related to desktop, countertop, shelf, and or wall mounted clocks with preset alarm capabilities. These alarm clocks are of mechanical, electrical, and electronic in nature and typically have a single preset alarm time that activates once per day. 2. The specifics of this invention embody a unique application where a microphone is built into the device to record a specific message or messages as applicable. Additional unique capability includes the ability to set multiple alarms, or as used in this context, alerts, to activate not only on a repetitive once per day basis, but also activate multiple times per day or activate singly or repetitively over a period of days or weeks or months for appointment schedules, medicinal reminders, or any other uses the user find appropriate and helpful. 3. Voice messages may also be left and set to activate manually or on a timed basis. The particular packaging and construction of the device could include several models from a basic multiple alert per day model to an advanced HiTech model with video capture capability depending on marketing research, public response and needs. The key and unique features incorporated are the built in voice recording system, the ability to program multiple alarms or alerts over extended periods of time limited only by device memory and specific construction-, and the use of still or moving video recordings in the alert and message functions.

### FIELD OF THE INVENTION

1. The present invention relates to alarm clocks as typically used in the home or other locations for personal use.

### BACKGROUND OF THE INVENTION

1. Common alarm clocks, either mechanical, electric, or electronic, typically have a single present alarm or alert available to sound an alarm at a single preset time during any one day period. Often these common alarm clocks have a built in radio and have the ability to use a tone or radio broadcast as the sounding method. This invention expands that aspect to a much higher level of performance, flexibility, and capability. The need for expanded features is apparent when one considers persons with repetitive reminder needs such as for medications or appointments. This invention adds new features to the common alarm clock to allow personalized programming to facilitate expanded functionality over a broader range of time with multiple alarm or alert presets.

### SUMMARY OF THE INVENTION

1. The Recording And Playing Alarm Clock is configured to serve a wide variety of personal needs and allows users to customize and program events further than one day into the future such as for appointments while also allowing single or multiple intraday alarms or reminders such as for medications. A unique feature is the ability to customize the alarms individually to suit any need including recording a specific voice reminder such as for appointments or medications. The specific voice recorded reminders can be set to occur at whatever time and or date interval the user requires and may be set to repeat every day, week, or month. This ability in a small compact device makes this clock a very versatile and useful instrument and may have special applicability to elderly persons.

2. In order to accomplish this versatility, this clock must have a built in microphone that will allow the user to record a specific message for later play. In a more advanced model, a specific message such as appointment, medications, birthday, or others may be internally available for use to signal an alert which then plays a recorded message once the user acknowledges the alert. For instance, an alarm using a built in synthesized voice alert may repeat the term “Medication” until the user pushes a alert recognition button at which time the users own recorded voice says “Time for sugar level test” in the case of diabetic needs. The specific feature of being able to record customized messages means uses are limited only by the users imagination or needs.

### BRIEF DESCRIPTION OF THE DRAWINGS

FIG. 1 is a Basic Model Electrical Description showing functional component requirements and embodiments.

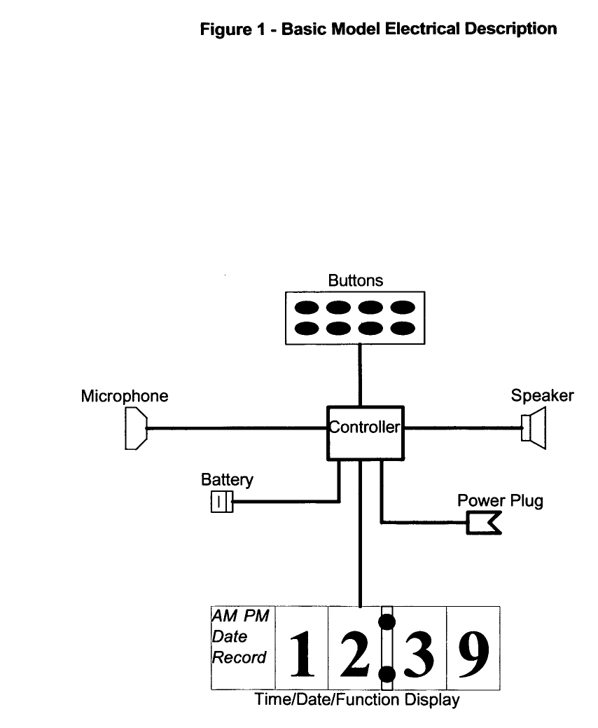

FIG. 2 is a Deluxe Model Electrical Description showing functional component requirements and embodiments.

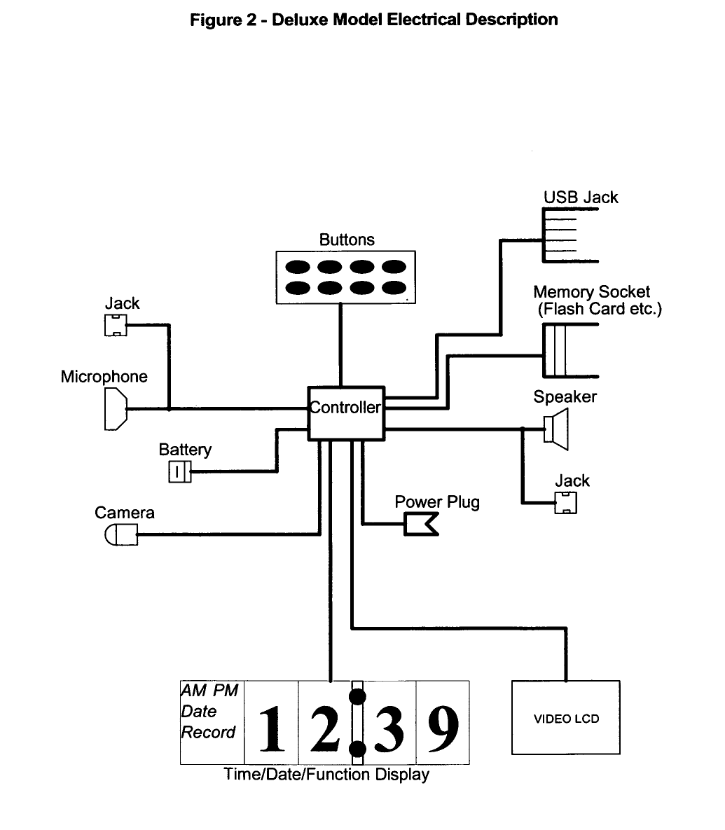

FIG. 3 is a HiTech model electrical description showing functional component requirements and embodiments.

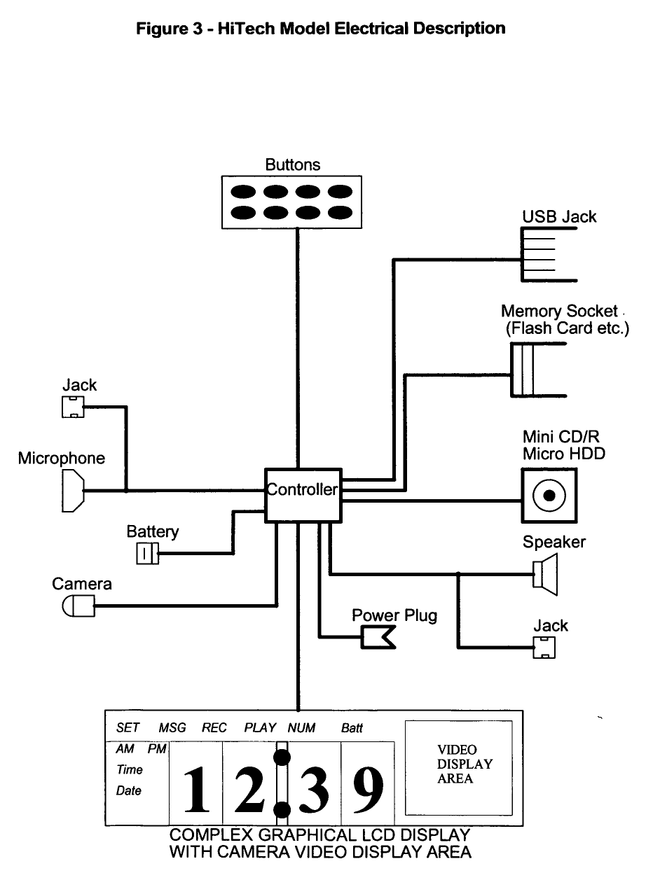

FIG. 4 is a concept drawing of how Basic tabletop model may appear and be laid out in actual production and embodiments.

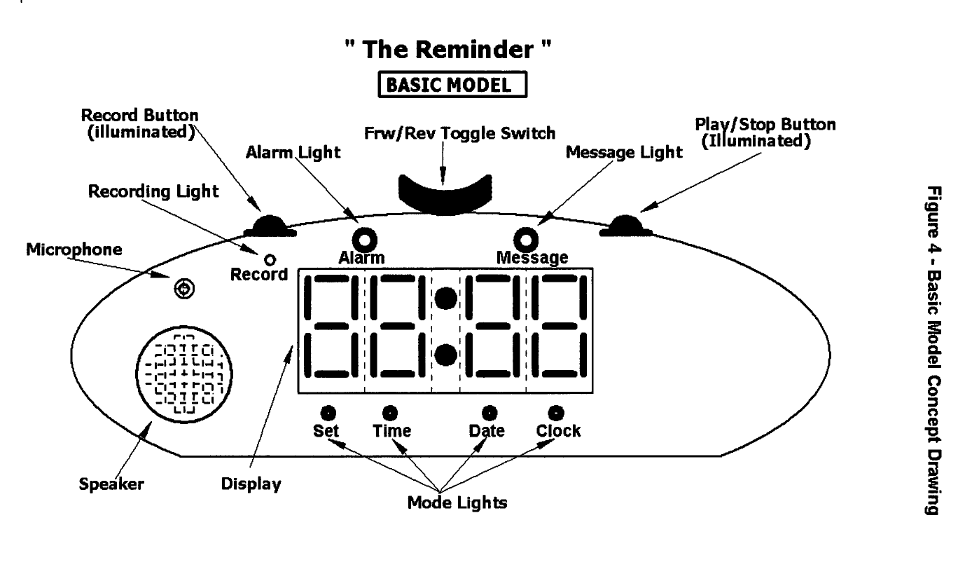

FIG. 5 is a concept drawing of how the Deluxe tabletop model may appear and be laid out in actual production.

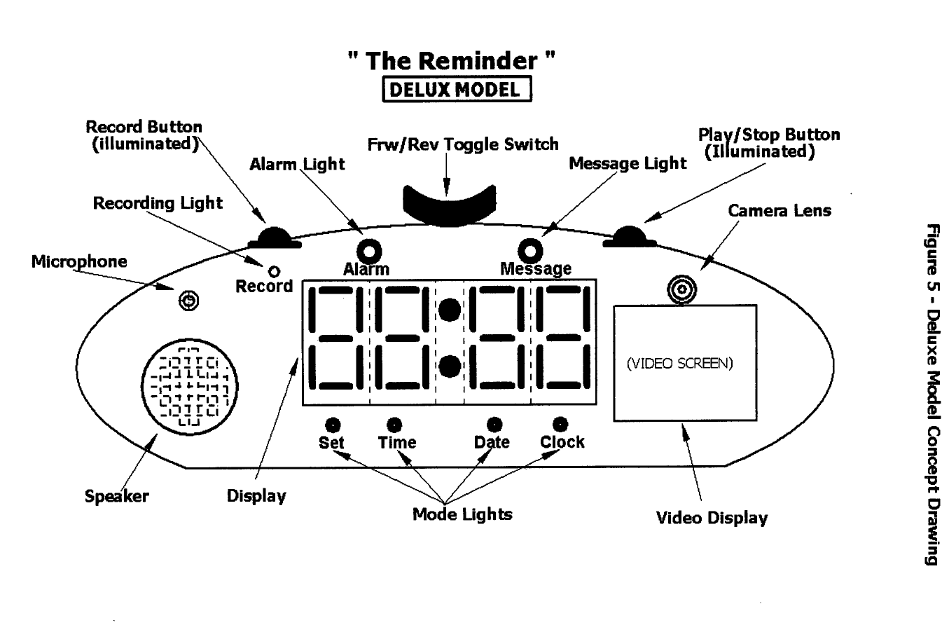

FIG. 6 is a concept drawing of how the HiTech tabletop model may appear and be laid out in actual production.

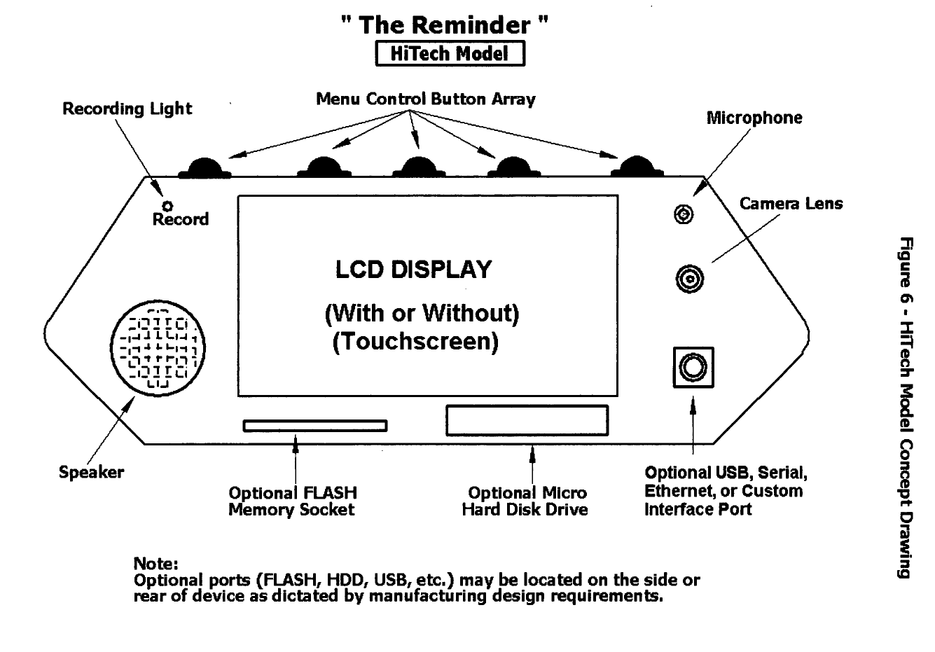

### DETAILED DESCRIPTION

1. The Recording And Playing alarm clock can have many functions or be very simple. The common desktop configuration is suggested, but wall mounting is an alternative. The recording and playing alarm clock can include such features as a calendar for extended timed and dated release of recordings for single and or multiple events, or have a few simple short recorded reminders triggered every day on a simple timed basis. Of necessity, all models will have basic alarm functions as found in any common alarm clock such as setting the current time and setting at least one alarm time with alarm on and off functions, and a built in microphone to record custom messages, sounds, or music. Some sort of internal battery will likely be required in case of power failure as is commonly used in most alarm clocks today. This battery could be built into the device or be a common customer installed item such as a nine volt battery.

2. The Recording And Playing alarm clock has any needed numeric, alphanumeric, or graphic display required to support the model specific features incorporated and to indicate the current mode of operation used to set dates, set times, current date, current time, record mode, message status, memory status, and any other feature required indication. The display may consist of simple segmented LED sections, use a full graphic LCD display with optional touch screen features, or be a custom designed hybrid.

3. The basic model could include just the combination of built in microphone for recording reminders activated at a preset times and or dates. Internal control uses an appropriate controller with memory to handle function control, appropriate button, display, input and output components for controlling the settings, time, date, voice record, play, and playback functions. The controller could be a custom chip or chip set or use commercially available components. The buttons and display may be of any configuration and physical dimension. The basic model may include capability to store more complex holiday, anniversary, appointment, or other special events of the users choosing.

4. A more deluxe model of the recording and playing alarm clock may include everything in the basic model with the addition of a video screen and camera to record still or live video as well as audio messages and reminders. It may include a much larger built in memory capability or external expansion memory capability by way of industry standard FLASH memory card, a micro hard disk drive, a micro tape cassette, or external connection to other bulk storage device via an industry standard interface such as firewire or universal serial bus. It may also include any combination of these standard storage devices as compliments the intended use. The deluxe model may have capability to store hours or days of messages limited only by the amount of memory available to the device either internally or through the use of industry standard memory expansion such as a mass storage device or custom memory expansion. Accessing stored data on a remote computer via a standard or custom connection is also possible.

5. An advanced HiTech model could include all the functions of the basic and deluxe models with a larger higher capacity illuminated graphic LCD display to display the time, date, and alarm functions as well as recorded still or moving video and include connections to support an interface to a network such as Ethernet or wireless network scheme. This model could also have the capability of supporting an industry standard laptop computer PCMCIA interface device such as a modem or Ethernet or wireless network card which could allow remote reminders to be sent over a network or phone system such as calling ones cell phone or work number to remind them of an appointment. It may also have a simple serial port interface to use with a dedicated software program provided with the product.

6. A compromise model may be equipped with any combination of features from any of the previously described concepts in paragraphs one through five as prescribed by detailed customer and marketing requirements; but always including the microphone for recording messages.

7. Buftons and other controls may consist of any combination of simple round or flat pushbuttons, toggle switches, rocker switches, or touch sensitive buttons. Any or all of the control buttons may be self illuminated or may work in conjunction with separate illuminators to help indicate the current mode of operation or current function. Illuminated buttons and displays also facilitate operation in the dark and would probably used for that reason alone.

8. Individual indicators may be of any type, but are typically LED type. Any indicator used may be of single color or multiple color and may have blinking or flashing capability to enhance functional operation. Indicators may include those to signify an active recording or playback function. Individual indicators may signal functions or other modes of operation such as a new message, year, day, time, hour, minutes, seconds, or any other required identifier to help the user navigate controls with confidence. In a HiTech model, the graphic display could blink and display a function name in English or other language as programmed by the user and supported by the device while being LED illuminated or standard lamp illuminated.

1. I claim the rights to a recording and playing multifunction alarm clock with built in microphone for sound recording with ability for playing of single or repeated, timed and or dated release of recordings and or alarms that can be set to activate several times within a day, and or days of the week, and or on weekends, and or by months, for alarms, alerts, reminders, messages, medications, appointments, events, holidays, and any other repetitive or single scheduled event.

2. I claim the rights to a combination of a multifunction alarm clock with a sound recording and playing device connected together for timed recordings and or playing with ability to delete and save messages individually.

3. I claim the rights to any software or firmware or computer program specifically used in support of or to remotely communicate with a recording and playing multifunction alarm clock with built in microphone as in claim 1 or claim 2.

4. As in claim 3 said software or computer program or firmware may run on a personal computer, business computer, personal digital assistant, and or other separate unique device or computerized system.

5. As in claim 3 said software or computer program or unique device specifically used to interface to a combination of multifunction alarm clock and sound recorder with built in microphone for the purposes of programming, and or monitoring, and or upgrading, and or updating, and or testing, and or enhancing or expanding the functionality of a recording and playing multifunction alarm clock with built in microphone as in claim 1 or claim 2.

6. As in claim 1 or claim 2 with built in calendar.

7. As in claim 1 or claim 2 with illuminated buttons.

8. As in claim 1 or claim 2 with separate built in mail boxes for multiple users.

9. As in claim 1 or claim 2 with built in camera and video screen for recording and playing of still or moving images.

10. As in claim 1 or claim 2 with a commodity or unique, built in or plug in, solid state memory expansion product such as a FLASH memory card.

11. As in claim 1 or claim 2 with a commodity or unique, built in or plug in, non-solid state memory expansion product such as a hard disk drive or CD-ROM drive.

12. As in claim 1 or claim 2 with a commodity or unique, built in or plug in, communications expansion port such as Firewire, Ethernet, USB, Serial, and or PCMCIA laptop expansion port such as for a wireless Ethernet PCMCIA card.

13. As in claim 1 or claim 2 with a direct sound and video output to hook up to a separate video and or sound monitors.

14. As in claim 1 or claim 2 with the ability to communicate with other separate recording and playing multifunction alarm clocks with built in microphone.
